(19) United States
(12) Patent Application Publication
(10) Pub. No.: US 2010/0263274 A1
(43) Pub. Date: Oct. 21, 2010

(54) ENCAPSULATED SEED ARTICLES AND METHOD OF MAKING SAME

(75) Inventors: Steven J. Corak, Raleigh, NC (US); James L. Hunter, Littleton, CO (US); Lloyd D. Le Page, Johnston, IA (US)

Correspondence Address: ALSTON & BIRD LLP;PIONEER HI-BRED INTERNATIONAL, INC., BANK OF AMERICA PLAZA, 101 SOUTH TRYON STREET, SUITE 4000, CHARLOTTE, NC, 28280-4000, US

(73) Assignee: Pioneer Hi-Bred International, Inc.

(21) Appl. No.: 12/758,632

(22) Filed: Apr. 12, 2010

Related U.S. Application Data
(60) Provisional application No. 61/169,492, filed on Apr. 15, 2009.

(51) Int. Cl. A01C 1/06; A01N 25/34

(52) U.S. Cl. 47/57.6; 504/100; 427/4

(57) ABSTRACT

In general the present invention provides various embodiments of an encapsulated seed article and a method for encapsulating a seed to form an encapsulated seed article. The encapsulated seed article may comprise one or more seeds that are encapsulated by a compressible encapsulation medium. In various embodiments, the encapsulated seed article may include a surface coating and/or an intermediate coating. In some embodiments, the encapsulated seed article may include an additive. In some embodiments, a characteristic or a combination of characteristics of the encapsulated seed article may be configured to identify a feature of encapsulated seed article. The present invention also provides various embodiments for a plurality of encapsulated seed articles having uniform seed article sizes or seed article shapes and a method for encapsulating a plurality of seeds to form a plurality of seed articles having uniform seed article sizes or seed article shapes.

### CROSS REFERENCE TO RELATED APPLICATIONS

The present application claims priority from U.S. Provisional Application No. 61/169,492, filed Apr. 15, 2009, which is hereby incorporated herein in its entirety by reference.

### FIELD OF THE INVENTION

The present invention generally relates to seed planting improvements. More specifically, the present invention relates to encapsulated seed articles and methods for encapsulating one or more seeds.

### BACKGROUND OF THE INVENTION

Although some areas of the world experience climates that present optimal growing conditions for various plants, other areas experience climates that inhibit, and in some cases prevent, plant growth. An inability to grow and cultivate plants, especially staple crops (such as for example, corn, rice, sorghum, soybeans, wheat, etc.), can have a devastating effect on the health and wellbeing of populations of people living in these areas.

In addition to climate concerns, there are other limiting factors that may affect the ability to successfully grow and cultivate plants. For example, many areas have soils that lack proper fertility, and many farmers in these areas do not have access to fertilizing agents. Insect and weed infestation may also present a problem, as well as the prevalence of animals that scavenge seeds shortly after planting. Additionally, even if some of these conditions are not problematic, many farmers in these areas lack general planting, cultivation, and harvesting knowledge needed to successfully generate food products from the plants. To address some of these problems, it would appear that educating farmers and others living in these areas about successful farming techniques may be an easy solution. Low literacy levels and various other factors, however, negatively affect these educational efforts. Furthermore, various market conditions may exist to counteract the successful generation of food products. In addition, conditions may exist that limit seed and/or food product transportation and distribution channels. For example, the high cost and time-consuming procedures associated with seed production, handling, and distribution may limit the availability of seeds in these areas. A portion of these costs can be attributed to the handling and sorting of seeds having a variety of sizes and shapes. Variability in seed sizes and shapes also poses challenges for farmers by increasing the time and costs associated with planting the seeds and by requiring the use of robust planting equipment.

As a result of the above, a need exists for articles and methods that facilitate successful handling, distribution, planting, and cultivation of seeds. Various embodiments of the articles and methods of the present invention should help alleviate some of the limiting factors listed above and should provide seed distributors and farmers with simplified handling and planting solutions. In addition, some embodiments of the articles and methods should aid farmers who lack planting and cultivation knowledge, and some embodiments should provide simplified pest, weed, and disease management solutions.

### BRIEF SUMMARY OF VARIOUS EMBODIMENTS

The present invention addresses the above needs and achieves other advantages by providing encapsulated seed articles and methods of producing encapsulated seed articles. In one embodiment, a plurality of encapsulated seed articles is provided with each encapsulated seed article generally comprising a seed intended to germinate into a plant, and a compressible encapsulation medium, wherein the encapsulation medium encapsulates substantially all of the seed to form the encapsulated seed article, wherein the encapsulated seed article defines a seed article size and a seed article shape, and wherein one of the seed article size or the seed article shape of the plurality of encapsulated seed articles is substantially uniform. In some embodiments, the encapsulation medium may be configured to be compressed around at least a portion of the seed. In some embodiments, both the seed article size and the seed article shape of the plurality of encapsulated seed articles may be substantially uniform. In some embodiments, the encapsulation medium may comprise a compressible foam material. In some embodiments, the compressible foam material may comprise a biodegradable starch material. In some embodiments, the biodegradable starch material may comprise a chemically modified starch material. In some embodiments, the encapsulation medium may comprise a cellulose-derived material. In some embodiments, each encapsulated seed article may form a shape selected from the group consisting of: substantially spherical, substantially cylindrical, and substantially ovoidal. In some embodiments, each encapsulated seed article may form a pillow shape.

In some embodiments, each encapsulated seed article may further include an additive. In some embodiments, the additive may be selected from the group consisting of: a micronutrient fertilizer, a macronutrient fertilizer, a fungicide, a herbicide, an insecticide, a feeding inhibitor, and combinations thereof. In some embodiments, the additive may be part of the encapsulation medium. In some embodiments, the encapsulating medium may encapsulate substantially all of the seed and the additive. In some embodiments, the additive may be positioned so as not to be in contact with the seed. In some embodiments, each encapsulated seed article may include at least one characteristic that is configured to identify one or more features of the encapsulated seed article. In some embodiments, the seed of each encapsulated seed article may be intended to germinate into a particular type of plant, and at least one characteristic of the encapsulated seed article may be configured to identify the seed or the particular type of plant. In some embodiments, the characteristic may include a characteristic selected from the group consisting of: a color or a combination of colors, a symbol or a combination of symbols, a text character or a combination of text characters, a bar code, a radio frequency identification transponder, and combinations thereof. In some embodiments, the characteristic may be displayed on at least a portion of an outer surface of the encapsulated seed article. In some embodiments, each encapsulated seed article may further include an additive, and at least one characteristic of the encapsulated seed article may be configured to identify the additive. In some embodiments, the characteristic may comprise at least one of the seed article size and the seed article shape.

In another embodiment, an encapsulated seed article is provided that generally comprises a seed intended to germinate into a plant and a compressible encapsulation medium, wherein the encapsulation medium is configured to be compressed around at least a portion of the seed so as to encapsulate substantially all of the seed to form the encapsulated seed article. In some embodiments, the encapsulation medium may comprise a compressible foam material. In some embodiments, the compressible foam material may comprise a biodegradable starch material. In some embodiments, the biodegradable starch material may comprise a chemically modified starch material. In some embodiments, the encapsulation medium may comprise a cellulose-derived material. In some embodiments, the encapsulated seed article may form a shape selected from the group consisting of substantially spherical, substantially cylindrical, and substantially ovoidal. In some embodiments, the encapsulated seed article may form a pillow shape.

Some embodiments may further comprise an additive. In some embodiments, the additive may be part of the encapsulation medium. In some embodiments, the additive may be selected from the group consisting of a micronutrient fertilizer, a macronutrient fertilizer, a fungicide, a herbicide, an insecticide, a feeding inhibitor, and combinations thereof. In some embodiments, the encapsulating medium may encapsulate substantially all of the seed and the additive. In some embodiments, the additive may be positioned so as not to be in contact with the seed. In some embodiments, the encapsulated seed article may include at least one characteristic that is configured to identify one or more features of the encapsulated seed article. In some embodiments, the seed may be intended to germinate into a particular type of plant, and at least one characteristic of the encapsulated seed article may be configured to identify the seed or the particular type of plant. In some embodiments, the characteristic may be selected from the group consisting of a color or a combination of colors, a symbol or a combination of symbols, a text character or a combination of text characters, a bar code, a radio frequency identification transponder, and combinations thereof. In some embodiments, the characteristic may be displayed on at least a portion of an outer surface of the encapsulated seed article. Some embodiments may further comprise an additive, and at least one characteristic of the encapsulated seed article may be configured to identify the additive. In some embodiments, the encapsulated seed article may further define a seed article size and a seed article shape, and the characteristic may comprises at least one of the seed article size and the seed article shape. Some embodiments may further comprise a surface coating disposed around at least a portion of an outer surface of the encapsulation medium. Some embodiments may further comprise an intermediate coating wherein an encapsulation medium may be disposed on an outer side of the intermediate coating.

In another embodiment, a method of encapsulating a plurality of seeds to form a plurality of encapsulated seed articles is provided that generally comprises receiving a plurality of seeds each intended to germinate into a plant, and encapsulating substantially all of each seed with a compressible encapsulation medium so as to form the plurality of encapsulated seed articles, wherein the encapsulated seed articles are formed so that each defines a seed article size and a seed article shape, and wherein one of the seed article size or the seed article shape of the plurality of encapsulated seed articles is substantially uniform. In some embodiments, the encapsulated seed articles may be formed so that both the seed article size and the seed article shape of the plurality of encapsulated seed articles are substantially uniform. In some embodiments, encapsulating substantially all of each seed with the encapsulation medium may comprise compressing a portion of the encapsulation medium around each seed such that substantially all of the seed is encapsulated by the encapsulation medium. In some embodiments, encapsulating substantially all of each seed with the encapsulation medium may comprise wrapping a portion of the encapsulation medium around each seed to form a pillow such that substantially all of the seed is encapsulated by the encapsulation medium.

In some embodiments, encapsulating substantially all of each seed with the encapsulation medium may include encapsulating substantially all of an additive with the seed. Some embodiments may further comprise positioning the additive within the encapsulated seed article so the additive is not in contact with the seed. Some embodiments may further comprise associating at least one characteristic with each of the encapsulated seed articles, and the characteristic may be configured to identify one or more features of the encapsulated seed article. In some embodiments, each of the encapsulated seed articles may be intended to germinate into a particular type of plant, and the characteristic may be configured to identify the seed or the particular type of plant.

In another embodiment, a method of encapsulating a seed to form an encapsulated seed article is provided that generally comprises receiving a seed intended to germinate into a plant, and compressing an encapsulation medium around at least a portion of the seed so as to encapsulated substantially all of the seed to form the encapsulated seed article. In some embodiments, compressing an encapsulation medium around at least a portion of the seed may comprise wrapping a portion of the encapsulation medium around the seed to form a pillow such that substantially all of the seed is encapsulated by the encapsulation medium.

In some embodiments, compressing an encapsulation medium around at least a portion of the seed may include encapsulating substantially all of an additive with the seed. Some embodiments may further comprise positioning the additive within the encapsulated seed article so the additive is not in contact with the seed. Some embodiments may further comprise associating at least one characteristic with the encapsulated seed article wherein the characteristic may be configured to identify one or more features of the encapsulated seed article. In some embodiments, the encapsulated seed article may be intended to germinate into a particular type of plant, and the characteristic may be configured to identify the seed or the particular type of plant. Some embodiments may further comprise including a surface coating on at least a portion of an outer surface of the encapsulation medium. Some embodiments may further comprise including an intermediate coating in the encapsulated seed article.

### BRIEF DESCRIPTION OF THE DRAWINGS

Having thus described the invention in general terms, reference will now be made to the accompanying drawings, which are not necessarily drawn to scale, and wherein:

FIG. 1 shows a perspective view of an encapsulated seed article comprising a seed encapsulated by a compressible encapsulation medium in accordance with an exemplary embodiment the present invention;

FIG. 1A shows the seed and the compressible encapsulation medium of the embodiment depicted in FIG. 1 before forming the encapsulated seed article;

FIG. 2 shows a cross-section view of an encapsulated seed article in accordance with an exemplary embodiment of the present invention;

FIG. 3 shows a perspective view of an encapsulated seed article comprising a seed encapsulated by a compressible encapsulation medium in accordance with an exemplary embodiment the present invention;

FIG. 3A shows the seed and the compressible encapsulation medium of the embodiment of FIG. 3 before forming the encapsulated seed article;

FIG. 4 shows a perspective view of encapsulated seed articles having other exemplary shapes in accordance with other embodiments of the present invention;

FIG. 5 shows a cross-section view of an encapsulated seed article in accordance with another exemplary embodiment of the present invention, wherein the encapsulated seed article includes an additive;

FIG. 6 shows a cross-section view of an encapsulated seed article in accordance with another exemplary embodiment of the present invention, wherein the encapsulated seed article includes a surface coating;

FIG. 7 shows a perspective view of several exemplary embodiments of the present invention wherein each encapsulated seed article includes at least one characteristic that is configured to identify one or more features of the encapsulated seed article;

FIG. 8 shows a perspective view a portion of a plurality of encapsulated seed articles in accordance with an exemplary embodiment of the present invention;

FIG. 9 shows a perspective view of respective portions of pluralities of encapsulated seed articles in accordance with an exemplary embodiment of the present invention;

FIG. 10 shows a perspective view of an encapsulated seed article comprising seeds and an additive encapsulated by a compressible encapsulation medium in accordance with another exemplary embodiment the present invention;

FIG. 10A shows a perspective view of the seeds and additive and the compressible encapsulation medium of FIG. 10 before forming the encapsulated seed article; and

FIG. 11 shows a perspective view of exemplary embodiments of the present invention wherein an encapsulated seed article includes at least one characteristic that is configured to identify one or more features of the encapsulated seed article.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

As noted above, many factors may affect the ability for successful distribution, planting, and cultivation of seeds. To alleviate some of these limiting factors, the present invention provides various embodiments of an encapsulated seed article and a method for encapsulating a seed to form an encapsulated seed article. The encapsulated seed article may comprise one or more seeds that are encapsulated by a compressible encapsulation medium. In various embodiments, the encapsulated seed article may include a surface coating and/or an intermediate coating. In some embodiments, the encapsulated seed article may include an additive. A characteristic or a combination of characteristics of the encapsulated seed article of some embodiments may be configured to identify a feature of encapsulated seed article. The present invention also provides various embodiments for a plurality of encapsulated seed articles having uniform seed article sizes or seed article shapes and a method for encapsulating a plurality of seeds to form a plurality of seed articles having uniform seed article sizes or seed article shapes. As a result, the present invention facilitates successful distribution, planting, and cultivation of seeds into plants. It also provides seed distributors and farmers with simplified handling and planting solutions, aids farmers who lack planting and cultivation knowledge, and provides simplified pest, weed, and disease management solutions.

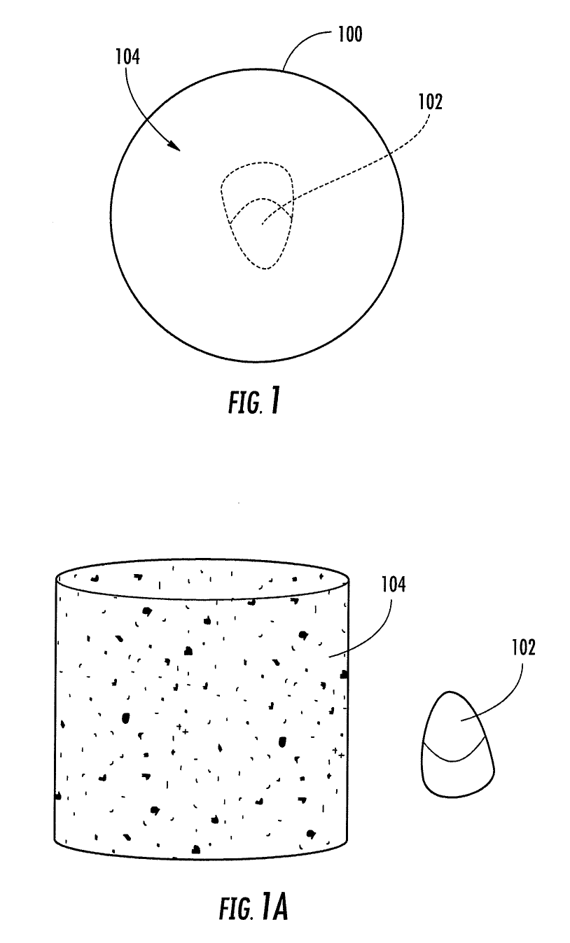

FIG. 1 shows a perspective view of an encapsulated seed article in accordance with an exemplary embodiment the present invention. In particular, a substantially spherical encapsulated seed article 100 is shown which is comprised of a seed 102 and a compressible encapsulation medium 104. FIG. 1A shows the seed 102 and the compressible encapsulation medium 104 of an exemplary embodiment of the present invention before forming the encapsulated seed article 100. In various embodiments, the compressible encapsulation medium may comprise a material that is configured to be compressed around the seed 102 so as to encapsulate substantially all of the seed 102. It should be noted that the size and shape of the compressible encapsulation material prior to forming the encapsulated seed article may vary. For example, in various embodiments the encapsulation material may be a separate component that is combined with a seed or seeds to create the encapsulated seed article. In other embodiments, the encapsulation material may be a larger source from which the needed encapsulation material is removed to create an encapsulated seed article. In still other embodiments, the encapsulation material and the seed or seeds may be mixed together and then formed into the encapsulated seed article. In still other embodiments, the encapsulation material may be separately extruded and combined with the seed or seeds, and in some embodiments, the seed or seeds may be included in the extruded material.

In various embodiments, examples of compressible encapsulation materials may include, but need not be limited to, foam materials, various starch materials including biodegradable starch materials and chemically modified starch materials, cellulose-derived materials, alginate materials, proteinaceous materials, etc. Examples of starch materials may include, but are not limited to, corn starch, potato starch, cassaya starch, and wheat starch materials. In some embodiments, such as those where the encapsulation material comprises a proteinaceous material, the material may be whipped or foamed into a foam material. In additional embodiments, other materials may be added to the foam, such as, for example, stabilizing materials. Thus, an exemplary embodiment may comprise an encapsulation medium that is made from a proteinaceous material that is whipped into a foam and stabilized with a stabilizing material, such as a non-nutritive material. In some embodiments, the encapsulation medium may advantageously include nitrogen in a form usable by the plant or plants.

In various embodiments, the encapsulation medium may increase the size of and/or standardize the shape of the seed(s). By increasing the size of and/or standardizing the shape of the seed(s), some embodiments may be advantageous for hand planting procedures and may improve hand planting ergonomics and worker safety, especially in those regions where hand-planting is the predominant planting practice; additionally, automated and semi-automated seed handling and planting procedures may be simplified. In various embodiments, the encapsulation medium may also protect the seed(s) after planting, such as, for example, from being consumed by animals. In some embodiments, the encapsulation medium may begin to degrade after a period of time or after being subjected to the environment, thus allowing the seed or seeds to germinate through the encapsulation medium. In various embodiments, the relative timing of the degradation of the encapsulation medium may be varied through different material choices and/or thicknesses. In such a manner, an encapsulated seed article may be produced that is configured for timed or controlled exposure of the one or more seeds.

In various embodiments the encapsulation medium may encapsulate a single seed or more than one seed. Additionally, the seed or seeds encapsulated by the encapsulation medium may be any seed or seeds intended to germinate into one or more plants, including, but not limited to, corn seed, rice seed, sorghum seed, soybean seed, wheat seed, grass seed, fruit seed, etc. Thus, although the seed 102 depicted in FIGS. 1 and 1A may be a corn seed, the articles and methods described and claimed herein are applicable to any seed or seeds, or any combination of seeds, intended to germinate into one or more plants. For the purpose of the current specification and the appended claims and drawings, it should be understood that the terms “plant or plants” shall be afforded their broadest definition so as to connote one or more living organisms belonging the plantae kingdom, including but not limited to, crops, trees, grasses, herbs, bushes, vines, etc.

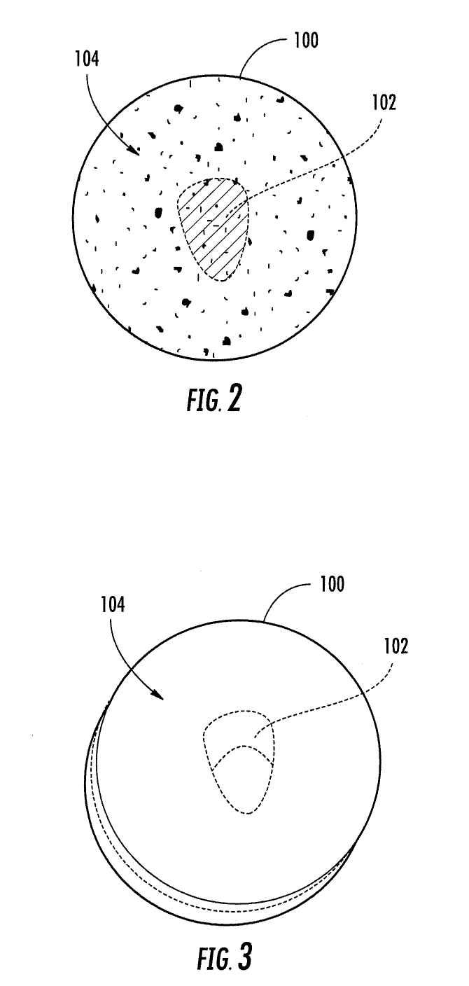

FIG. 2 shows a cross-section view of a substantially spherical encapsulated seed article 100 in accordance with an exemplary embodiment of the present invention. As shown in the figure, the seed 102 is substantially encapsulated by the compressible encapsulation medium 104. It should be noted that although the seed 102 of the depicted embodiment is shown roughly positioned in the center of the encapsulated seed article 100, in other embodiments the seed may be located in other positions within the encapsulated seed article and need not be centered. Additionally, various embodiments of the present invention may include two or more layers of encapsulation media, and, in some embodiments, the layers of encapsulation media may differ in type such that more than one type of encapsulation media may be present in a single encapsulated seed article. In some embodiments, by including different types of encapsulation media, the timing of the degradation of the encapsulation media may be further varied or customized for particular applications. In such a manner, an encapsulated seed article may be produced that is configured for timed or controlled exposure of the one or more seeds.

In some embodiments, the encapsulated seed article 100 is formed by compressing the compressible encapsulation medium 104 around the seed 102 so that the seed 102 is substantially encapsulated by the compressible encapsulation medium 104. In various embodiments, compressing the compressible encapsulation medium 104 may be achieved through a variety of methods, including manual or automated methods. Examples of manual methods include, but need not be limited to, using an operator's hands to compress the compressible encapsulation medium around the seed, or using one or more manual tools, such as a levered tool which is configured to compress the compressible encapsulation medium around the seed. Examples of automated methods include, but need not be limited to, automated devices configured to compress the compressible encapsulation medium around the seed, or automated molding devices configured to inject the compressible encapsulation medium into a mold containing the seed so that compressible encapsulation medium is compressed around the seed.

Encapsulated seed articles may be created in other ways such as mixing the seed or seeds with a foam producing agent and co-extruding the mixture, extruding the foaming agent and then inserting the seed or seeds into the extruded foam prior to compressing the extruded foam around the seed(s), or producing the encapsulating media and then deforming the media to encapsulate the seed(s). In some embodiments the process may include various steps. For example, in one embodiment, a two step process may comprise producing the encapsulating material in one process and supplying it to a separate encapsulation process. In other embodiments the process may be a single step. For example, one embodiment may comprise forcing the carried seed through an orifice after which the compressible encapsulating media expands around the seed and is subsequently shaped into the desired form.

FIG. 3 shows a perspective view of an encapsulated seed article 100 comprising an encapsulation medium 104 and a seed 102 in accordance with another exemplary embodiment the present invention. FIG. 3A shows the seed 102 and the compressible encapsulation medium 104 of the embodiment of FIG. 3 before forming the encapsulated seed article 100. In the depicted embodiment, the encapsulation medium 104 is removed from a sheet 104A of encapsulation material to a desired shape. In particular, the desired shape is removed using a die punch and includes a pair of disk-shaped halves that are joined together thus allowing the seed 102 (or seeds) to be placed between the halves and the halves folded over such that the encapsulation medium 104 encapsulated substantially all of the seed 102. In other embodiments, a desired shape may be created in many different ways and, as noted above, in various other embodiments various other shapes and sizes may be created.

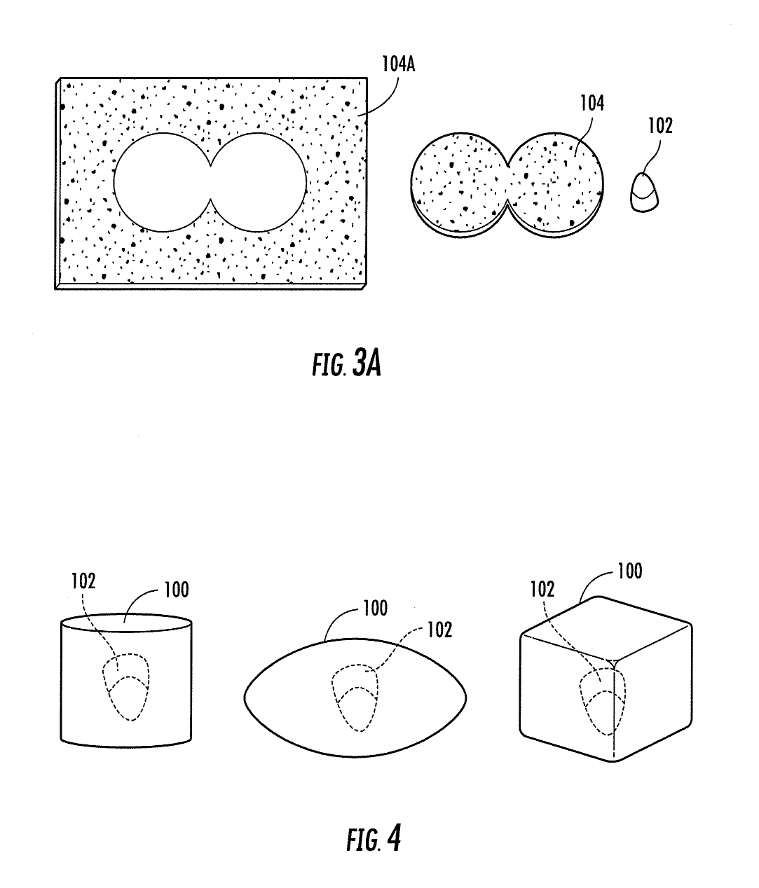

Referring to FIGS. 1-2, the encapsulated seed article 100 is shown by example as being formed into a shape that is substantially spherical. In other embodiments, however, the encapsulated seed article may be formed into any shape that substantially encapsulates the seed. Such shapes may include, but need not be limited to, cylinder shapes, rectangular prism shapes, ovoidal shapes, pillow shapes, and various other regular or irregular shapes. By way of example, FIG. 4 shows three encapsulated seed articles 100, one having a substantially cylindrical shape, another having a substantially ovoidal shape, and another having a substantially cubic shape.

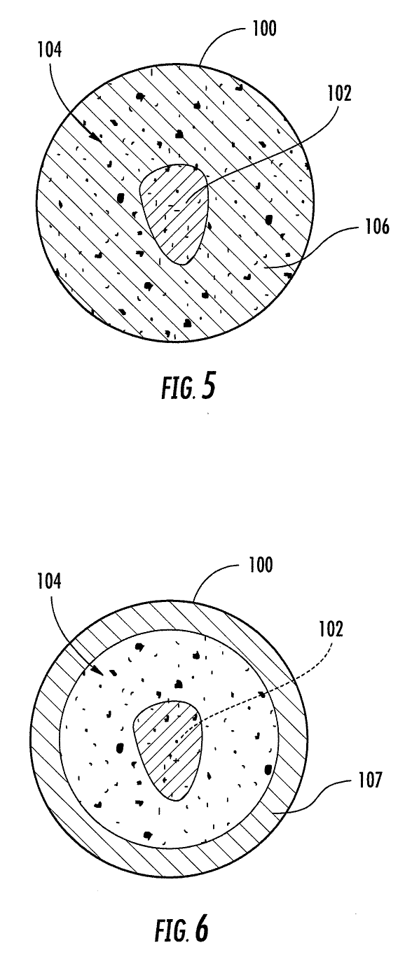

In addition to providing protection for the seed or seeds, in various embodiments an encapsulated seed article may facilitate germination and cultivation of plants by including one or more additives. FIG. 5 shows a cross-section view of an encapsulated seed article 100 in accordance with another exemplary embodiment of the present invention. In the depicted embodiment, the encapsulated seed article 100 includes a seed 102 substantially encapsulated by an encapsulation medium 104 that includes an additive 106. In the depicted embodiment, the additive 106 is mixed into the encapsulation medium 104, however in other embodiments the additive 106 may represent a separate component within the encapsulated seed article 100. In some embodiments, it may be desirable to locate the additive adjacent the seed or seeds, while in other embodiments it may be desirable to separate the additive from the seed or seeds. In various embodiments, the additive 106 may be any additive configured to facilitate germination, protection, and/or cultivation of the seed or seeds, including, but not limited to, a micronutrient fertilizer, a macronutrient fertilizer, a fungicide, a herbicide, an insecticide, a feeding inhibitor (such as, for example, a bird or rodent repellant), and combinations thereof.

In some embodiments, a surface coating may be included on the encapsulated seed article. In such embodiments, the surface coating may serve a variety of functions, including, but not limited to, further protecting the encapsulated seed article and/or delaying or retarding degradation of the encapsulation medium. Surface coatings may also comprise any one or any combination of additives, such as, for example, the additives described herein. FIG. 6 shows a cross-section view of an encapsulated seed article 100 in accordance with another exemplary embodiment of the present invention wherein the encapsulated seed article 100 includes a surface coating 107. In the depicted embodiment, the surface coating 107 is disposed around substantially all of an outer surface of the encapsulation medium 104, however in other embodiments the surface coating 107 may be disposed around only a portion of an outer surface of the encapsulation medium. Additionally, it should be noted that the thickness of the surface coating 107 may vary in different embodiments, and the thickness may be selected depending on the intended function of the surface coating. In additional embodiments, one or more additives may be included in the surface coating.

In still other embodiments, one or more intermediate coatings (not shown) may be included in an encapsulated seed article. In some embodiments, one or more additives may be included in the intermediate coating. In various embodiments, intermediate coatings may include coatings located directly on the seed or seeds such that encapsulation medium is disposed on an outer side of the coating. Intermediate coatings may also include coatings where encapsulation medium is present on an inner side and an outer side of the coating. It should be noted that embodiments that include an intermediate coating may or may not include a surface coating. Additionally, in some embodiments the type of encapsulation medium located on an inner side of the intermediate coating may vary from the type of encapsulation medium located on an outer side of the intermediate coating. In some embodiments, by using surface coatings and/or intermediate coatings, the timing of the degradation of the encapsulation medium may be varied or customized for a particular application. Thus, through strategic material choices and strategic positioning of various components, encapsulated seed articles may be produced that permit controlled timing of the relative exposures of the seed or seeds and any additive element(s).

As noted above, in many areas of the world farmers lack general planting, cultivation, and harvesting knowledge needed to successfully germinate plants from seeds. Low literacy levels and other factors further exacerbate this problem. As a result, in some embodiments of the present invention, the encapsulated seed article may have associated with it at least one characteristic that is configured to identify one or more features of the encapsulated seed article. In various embodiments, the characteristic may be any human perceivable or machine perceivable characteristic. Examples of the characteristics include, but need not be limited to, any one or any combination of the following: colors, symbols, text characters, surface textures, surface embossments, bar codes, radio frequency identification (RFID) transponders, seed article sizes, seed article shapes, etc. In various embodiments, the characteristic may be included with the encapsulated seed article, and in some embodiments, the characteristic may be displayed on at least a portion of an outer surface of the encapsulated seed article. In various embodiments the feature of the encapsulated seed article identified by the characteristic may be any feature of the encapsulated seed article. Examples of features of the encapsulated seed article include, but are not limited to, the type(s) of seed(s) contained in the encapsulated seed article, the type(s) of plant(s) intended to germinate from the seed(s) in the encapsulated seed article, the source of the seed(s) (such as, for example, the producing company), the number of seeds included in the encapsulated seed article, and/or any additive(s) included with the seed(s). For the purpose the current specification and appended claims and drawings, the “type” of plant may include, but is not limited to, plant species, varieties of plant species, hybrids of plants species, or plants having one or more specific value-added traits, whether derived through conventional breeding an/or transgenic modification.

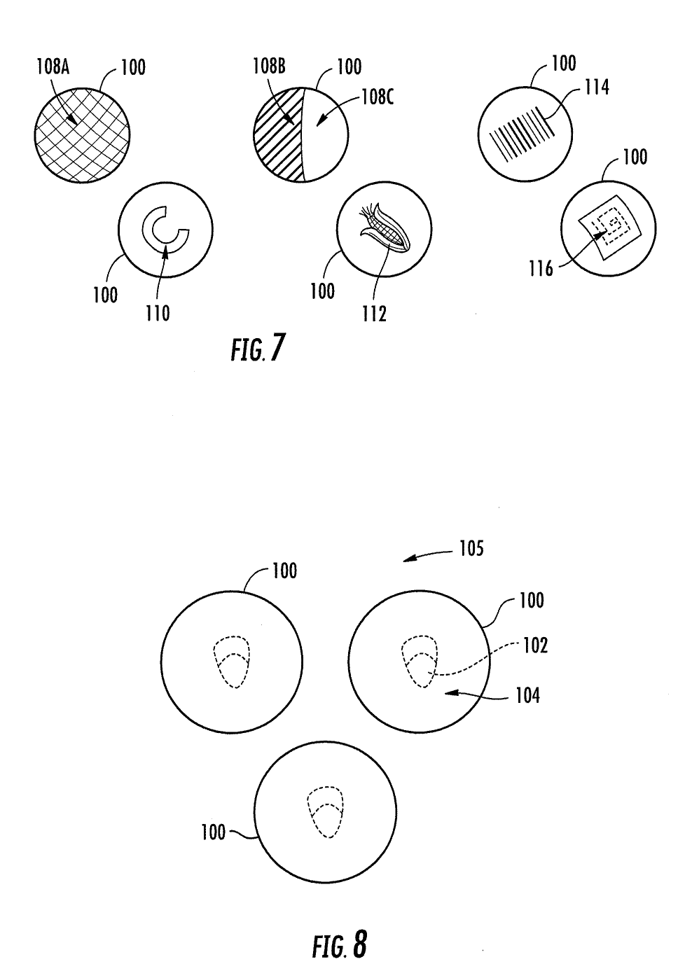

FIG. 7 shows a perspective view of several exemplary embodiments of the present invention wherein each encapsulated seed article 100 includes at least one characteristic that is configured to identify one or more features of the encapsulated seed article. In particular, FIG. 7 shows respective encapsulated seed articles 100 having characteristics in the form of a surface color 108A, a surface text character 110, a combination of surface colors 108B, 108C, a surface symbol 112, a bar code 114, and an RFID transponder 116. In some embodiments, combinations of characteristics may be configured to identify a single feature, or to identify multiples features of the encapsulated seed article.

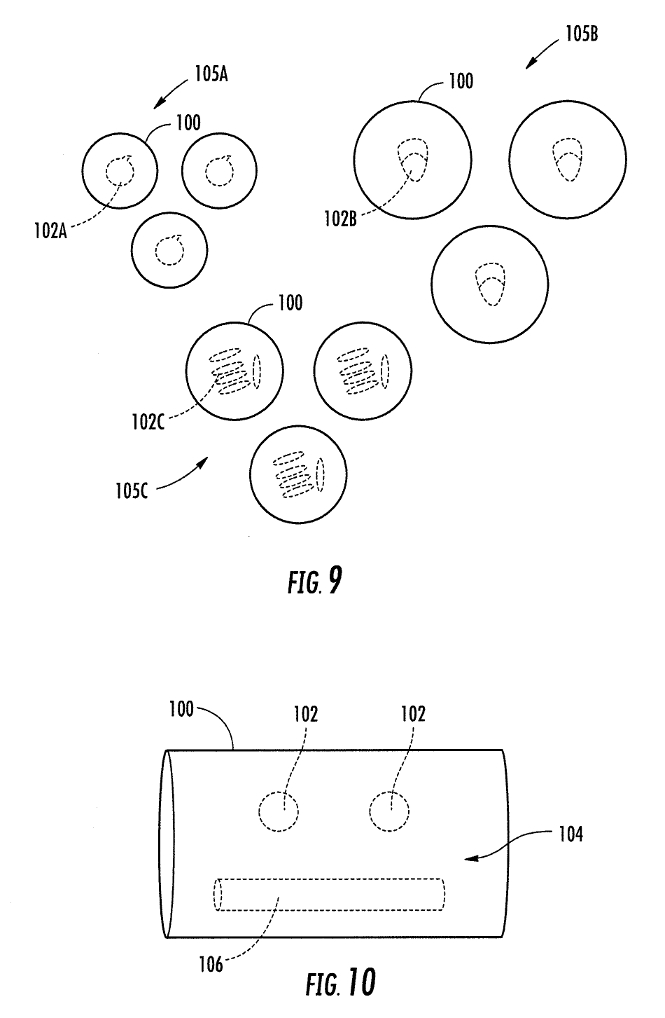

Because of their relatively small size and irregular shapes, many encapsulated seeds are often difficult to handle (either manually or through automated means). By encapsulating one or more seeds in an encapsulation medium, a larger more uniform shape is possible. FIG. 8 shows a perspective view of a representative portion of a plurality of encapsulated seed articles in accordance with another embodiment of the present invention. As shown in the figure, a plurality 105 of encapsulated seed articles 100 may be formed wherein each encapsulated seed article 100 includes a seed 102 and a compressible encapsulation medium 104 that encapsulates substantially all of the seed 102. (Note that in various embodiments, a plurality may include two or more encapsulated seed articles.) In the depicted embodiment, each encapsulated seed article 100 of the plurality 105 has a substantially uniform seed article size and a substantially uniform seed article shape. By providing pluralities of encapsulated seed articles having uniform seed articles sizes and/or shapes, embodiments of the present invention may simplify planting operations and handling procedures for seed producers and farmers, thus reducing associated costs. In various embodiments, this may be advantageous for both manual planting (for example, by improving planting ergonomics and worker safety) and automated or semi-automated planting (for example, by simplifying seed handling mechanisms). It should be noted that although in the depicted embodiment both the seed article size and the seed article shape of the plurality of encapsulated seed articles are uniform, in some embodiments either the seed article size or the seed article shape may be substantially uniform. Additionally, in other embodiments, a common characteristic such as one or more of the characteristics described above may also be associated with the plurality 105 of encapsulated seed articles 100 wherein the characteristic may be configured to identify a feature of the encapsulated seed articles 100 of the plurality 105.

In still other embodiments, the seed article size and/or seed article shape may serve as a characteristic that is configured to identify one or more features of the encapsulated seed article. FIG. 9 shows a perspective view of representative portions of pluralities 105A-C of encapsulated seed articles 100 in accordance with an exemplary embodiment of the present invention. As shown in the figure, each plurality 105A-105C comprises a group of encapsulated seed articles 100 that are substantially uniform in seed article size and seed article shape, however the seed article sizes are different between the pluralities 105A-C. In such a manner, for example, plurality 105A may be distinguished from pluralities 105B and 105C so as to indicate that the encapsulated seed articles 100 of plurality 105A have a feature that is different from a feature of pluralities 105B and 105C. In a similar manner, plurality 105B may be distinguished from pluralities 105A and 105C to indicate that the encapsulated seed articles 100 of plurality 105B have a feature that is different from a feature of pluralities 105A and 105C, and plurality 105C may be distinguished from pluralities 105A and 105B to indicate that the encapsulated seed articles 100 of plurality 105C have a feature that is different from a feature of pluralities 105A and 105B.

Although in various embodiments the seed article sizes and/or seed article shapes may be configured to identify any feature of the encapsulated seed articles, in the depicted embodiment, by way of example, the different seed article sizes of pluralities 105A-C are representative of the different seeds 102A-C encapsulated within the encapsulated seed articles 100 of each plurality 105A-C. In particular, in the depicted embodiment the seed article size of the encapsulated seed articles 100 of plurality 105A may be configured to indicate that the encapsulated seed articles 100 of this plurality include sorghum seeds 102A, the seed article size of the encapsulated seed articles 100 of plurality 105B may be configured to indicate that the encapsulated seed articles 100 of this plurality include corn seeds 102B, and the seed article size of the encapsulated seed articles 100 of plurality 105C may be configured to indicate that the encapsulated seed articles 100 of this plurality include rice seeds 102C.

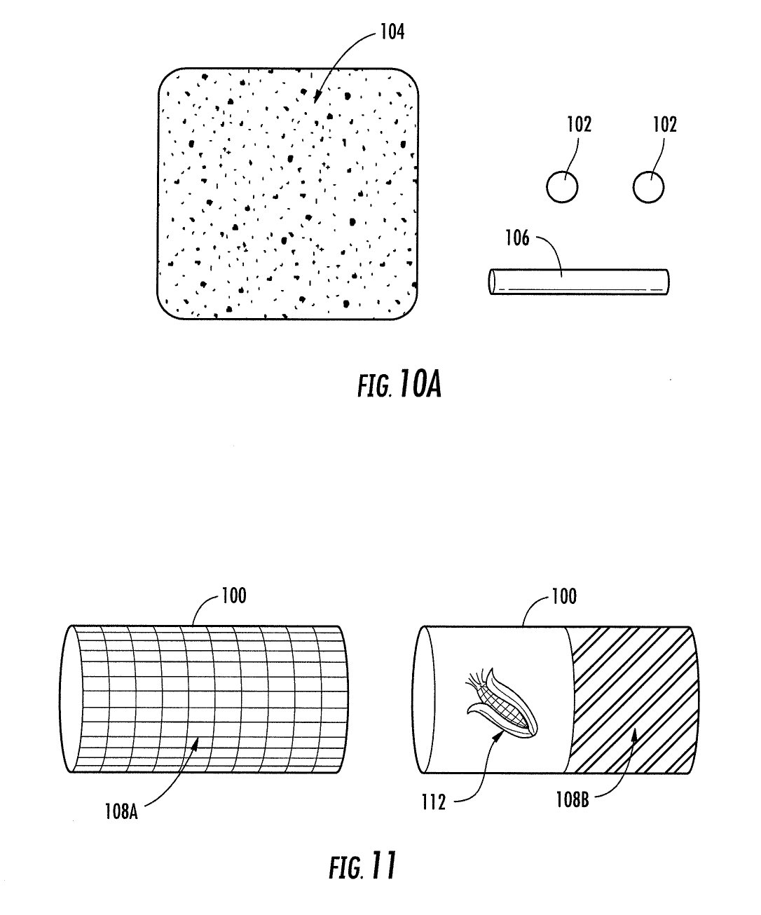

As noted above, in various embodiments an encapsulated seed article may have a variety of shapes, including a pillow shape, which may also facilitate manual planting and may improve planting ergonomics and worker safety. FIG. 10 shows a perspective view of a pillow-shaped encapsulated seed article 100 comprising a pair of seeds 102 and an additive 106 encapsulated by a compressible encapsulation medium 104 in accordance with an exemplary embodiment the present invention. FIG. 10A shows the seeds 102, additive 106, and compressible encapsulation medium 104 of FIG. 10 shown before forming the encapsulated seed article 100. It should be noted that although the depicted embodiment shows a pillow-shaped encapsulated seed article 100 comprising a pair of seeds 102 and an additive 106, in other embodiments an encapsulated seed article may be formed that encapsulates a plurality of seeds, or a single seed, and the encapsulated seed article need not include an additive element. In the depicted embodiment the pillow-shaped encapsulated seed article 100 is formed by wrapping the encapsulation medium 104 around the seeds 102 and additive 106 such that the seeds 102 and additive 106 are substantially encapsulated by the compressible encapsulation medium. In other embodiments a pillow-shaped encapsulated seed article may be formed in a variety of other ways, including manual or automated methods. In some embodiments, it may be desirable to separate the additive from the seed. For example, FIG. 10 depicts an additive 106 (shown by example as a fertilizer stick) which is separated from the seeds 102. It should be noted that one or more additives may also be separated from a seed in encapsulated seed articles having other various other shapes.

In various embodiments the pillow-shaped encapsulated seed article may include at least one characteristic that is configured to identify one or more features of the encapsulated seed article. As noted above, the characteristic may be any perceivable characteristic, including human perceivable and machine perceivable characteristics. Examples of characteristics include, but need not be limited to, any one or any combination of the following: colors, symbols, text characters, surface textures, surface embossments, bar codes, radio frequency identification (RFID) transponders, seed article sizes, seed article shapes, etc. In various embodiments the identified feature may be any feature of the encapsulated seed article. Examples of features of the encapsulated seed article include, but are not limited to, the type(s) of seed(s) contained in the encapsulated seed article, the type(s) of plant(s) intended to germinate from the seed(s) in the encapsulated seed article, and/or any additive(s) included with the seed(s).

FIG. 11 shows a perspective view of exemplary embodiments of the present invention wherein each encapsulated seed article 100 includes at least one characteristic that is configured to identify one or more features of the encapsulated seed article. In particular, FIG. 11 shows respective encapsulated seed articles 100 having characteristics in the form of a surface color 108A, and a combination of a surface symbol 112 and a surface color 108B. In some embodiments, combinations of characteristics may be configured to identify a single feature, or multiples features of the encapsulated seed article, such as for example, the type of seed contained in the encapsulated seed article as well as an additive that is included in the encapsulated seed article.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A plurality of encapsulated seed articles, each encapsulated seed article comprising:
a seed intended to germinate into a plant; and
a compressible encapsulation medium,
wherein the encapsulation medium encapsulates substantially all of the seed to form the encapsulated seed article, wherein the encapsulated seed article defines a seed article size and a seed article shape, and wherein one of the seed article size or the seed article shape of the plurality of encapsulated seed articles is substantially uniform.

2. The plurality of encapsulated seed articles of claim 1, wherein the encapsulation medium is configured to be compressed around at least a portion of the seed.

3. The plurality of encapsulated seed articles of claim 1, wherein both the seed article size and the seed article shape of the plurality of encapsulated seed articles are substantially uniform.

4. The plurality of encapsulated seed articles of claim 1, wherein the encapsulation medium comprises a compressible foam material.

5. The plurality of encapsulated seed articles of claim 4, wherein the compressible foam material comprises a biodegradable starch material.

6. The plurality of encapsulated seed articles of claim 5, wherein the biodegradable starch material comprises a chemically modified starch material.

7. The plurality of encapsulated seed articles of claim 1, wherein the encapsulation medium comprises a cellulose-derived material.

8. The plurality of encapsulated seed articles of claim 1, wherein each encapsulated seed article forms a shape selected from the group consisting of:
substantially spherical;
substantially cylindrical; and
substantially ovoidal.

9. The plurality of encapsulated seed articles of claim 1, wherein each encapsulated seed article forms a pillow shape.

10. The plurality of encapsulated seed articles of claim 1, wherein each encapsulated seed article further includes an additive.

11. The plurality of encapsulated seed articles of claim 10, wherein the additive is selected from the group consisting of:
a micronutrient fertilizer;
a macronutrient fertilizer;
a fungicide;
a herbicide;
an insecticide;
a feeding inhibitor; and
combinations thereof.

12. The plurality of encapsulated seed articles of claim 10, wherein the additive is part of the encapsulation medium.

13. The plurality of encapsulated seed articles of claim 10, wherein the encapsulating medium encapsulates substantially all of the seed and the additive.

14. The plurality of encapsulated seed articles of claim 10, wherein the additive is positioned so as not to be in contact with the seed.

15. The plurality of encapsulated seed articles of claim 1, wherein each encapsulated seed article includes at least one characteristic that is configured to identify one or more features of the encapsulated seed article.

16. The plurality of encapsulated seed articles of claim 15, wherein the seed of each encapsulated seed article is intended to germinate into a particular type of plant, and wherein at least one characteristic of the encapsulated seed article is configured to identify the seed or the particular type of plant.

17. The plurality of encapsulated seed articles of claim 15, wherein the characteristic includes a characteristic selected from the group consisting of:
a color or a combination of colors;
a symbol or a combination of symbols;
a text character or a combination of text characters;
a bar code;
a radio frequency identification transponder; and
combinations thereof.

18. The plurality of encapsulated seed articles of claim 17, wherein the characteristic is displayed on at least a portion of an outer surface of the encapsulated seed article.

19. The plurality of encapsulated seed articles of claim 15, wherein each encapsulated seed article further includes an additive, and wherein at least one characteristic of the encapsulated seed article is configured to identify the additive.

20. The plurality of encapsulated seed articles of claim 15, wherein the characteristic comprises at least one of the seed article size and the seed article shape.

21. An encapsulated seed article comprising:
a seed intended to germinate into a plant; and
a compressible encapsulation medium,
wherein the encapsulation medium is configured to be compressed around at least a portion of the seed so as to encapsulate substantially all of the seed to form the encapsulated seed article.

22. The encapsulated seed article of claim 21, wherein the encapsulation medium comprises a compressible foam material.

23. The encapsulated seed article of claim 22, wherein the compressible foam material comprises a biodegradable starch material.

24. The encapsulated seed article of claim 22, wherein the biodegradable starch material comprises a chemically modified starch material.

25. The encapsulated seed article of claim 21, wherein the encapsulation medium comprises a cellulose-derived material.

26. The encapsulated seed article of claim 21, wherein the encapsulated seed article forms a shape selected from the group consisting of:
substantially spherical;
substantially cylindrical; and
substantially ovoidal.

27. The encapsulated seed article of claim 21, wherein the encapsulated seed article forms a pillow shape.

28. The encapsulated seed article of claim 21, further comprising an additive.

29. The encapsulated seed article of claim 28, wherein the additive is part of the encapsulation medium.

30. The encapsulated seed article of claim 28, wherein the additive is selected from the group consisting of:
a micronutrient fertilizer;
a macronutrient fertilizer;
a fungicide;
a herbicide;
an insecticide;
a feeding inhibitor; and
combinations thereof.

31. The encapsulated seed article of claim 28, wherein the encapsulating medium encapsulates substantially all of the seed and the additive.

32. The encapsulated seed article of claim 28, wherein the additive is positioned so as not to be in contact with the seed.

33. The encapsulated seed article of claim 21, wherein the encapsulated seed article includes at least one characteristic that is configured to identify one or more features of the encapsulated seed article.

34. The encapsulated seed article of claim 33, wherein the seed is intended to germinate into a particular type of plant, and wherein at least one characteristic of the encapsulated seed article is configured to identify the seed or the particular type of plant.

35. The encapsulated seed article of claim 33, wherein the characteristic is selected from the group consisting of:
a color or a combination of colors;
a symbol or a combination of symbols;
a text character or a combination of text characters;
a bar code;
a radio frequency identification transponder; and
combinations thereof.

36. The encapsulated seed article of claim 35, wherein the characteristic is displayed on at least a portion of an outer surface of the encapsulated seed article.

37. The encapsulated seed article of claim 33, further comprising an additive, and wherein at least one characteristic of the encapsulated seed article is configured to identify the additive.

38. The encapsulated seed article of claim 33, wherein the encapsulated seed article further defines a seed article size and a seed article shape, and wherein the characteristic comprises at least one of the seed article size and the seed article shape.

39. The encapsulated seed article of claim 21, further comprising a surface coating disposed around at least a portion of an outer surface of the encapsulation medium.

40. The encapsulated seed article of claim 21, further comprising an intermediate coating wherein an encapsulation medium is disposed on an outer side of the intermediate coating.

41. A method of encapsulating a plurality of seeds to form a plurality of encapsulated seed articles, said method comprising:
receiving a plurality of seeds each intended to germinate into a plant; and
encapsulating substantially all of each seed with a compressible encapsulation medium so as to form the plurality of encapsulated seed articles,
wherein the encapsulated seed articles are formed so that each defines a seed article size and a seed article shape, and wherein one of the seed article size or the seed article shape of the plurality of encapsulated seed articles is substantially uniform.

42. The method of encapsulating a plurality of seeds of claim 41, wherein the encapsulated seed articles are formed so that both the seed article size and the seed article shape of the plurality of encapsulated seed articles are substantially uniform.

43. The method of encapsulating a plurality of seeds of claim 41, wherein encapsulating substantially all of each seed with the encapsulation medium comprises compressing a portion of the encapsulation medium around each seed such that substantially all of the seed is encapsulated by the encapsulation medium.

44. The method of encapsulating a plurality of seeds of claim 41, wherein encapsulating substantially all of each seed with the encapsulation medium comprises wrapping a portion of the encapsulation medium around each seed to form a pillow such that substantially all of the seed is encapsulated by the encapsulation medium.

45. The method of encapsulating a plurality of seeds of claim 41, wherein encapsulating substantially all of each seed with the encapsulation medium includes encapsulating substantially all of an additive with the seed.

46. The method of encapsulating a plurality of seeds of claim 45, further comprising positioning the additive within the encapsulated seed article so the additive is not in contact with the seed.

47. The method of encapsulating a plurality of seeds of claim 41, further comprising associating at least one characteristic with each of the encapsulated seed articles and wherein the characteristic is configured to identify one or more features of the encapsulated seed article.

48. The method of encapsulating a plurality of seeds of claim 47, wherein each of the encapsulated seed articles is intended to germinate into a particular type of plant, and wherein the characteristic is configured to identify the seed or the particular type of plant.

49. A method of encapsulating a seed to form an encapsulated seed article, said method comprising:
receiving a seed intended to germinate into a plant; and
compressing an encapsulation medium around at least a portion of the seed so as to encapsulated substantially all of the seed to form the encapsulated seed article.

50. The method of encapsulating a seed of claim 49, wherein compressing an encapsulation medium around at least a portion of the seed comprises wrapping a portion of the encapsulation medium around the seed to form a pillow such that substantially all of the seed is encapsulated by the encapsulation medium.

51. The method of encapsulating a seed of claim 49, wherein compressing an encapsulation medium around at least a portion of the seed includes encapsulating substantially all of an additive with the seed.

52. The method of encapsulating a seed of claim 51, further comprising positioning the additive within the encapsulated seed article so the additive is not in contact with the seed.

53. The method of encapsulating a seed of claim 51, further comprising associating at least one characteristic with the encapsulated seed article wherein the characteristic is configured to identify one or more features of the encapsulated seed article.

54. The method of encapsulating a seed of claim 53, wherein the encapsulated seed article is intended to germinate into a particular type of plant, and wherein the characteristic is configured to identify the seed or the particular type of plant.

55. The method of encapsulating a seed of claim 49, further comprising including a surface coating on at least a portion of an outer surface of the encapsulation medium.

56. The method of encapsulating a seed of claim 49, further comprising including an intermediate coating in the encapsulated seed article.
